(19) United States
(12) Patent Application Publication
(10) Pub. No.: US 2004/0239006 A1
(43) Pub. Date: Dec. 2, 2004

(54) Silicone compositions, methods of making, and uses thereof

(75) Inventor: Harry H. Hong, Artesia, CA (US)

Correspondence Address: MICROFABRICA INC., DENNIS R. SMALLEY, 1103 W. ISABEL ST., BURBANK, CA, 91506, US

(73) Assignee: Microfabrica Inc.

(21) Appl. No.: 10/763,594

(22) Filed: Jan. 22, 2004

Related U.S. Application Data
(60) Provisional application No. 60/442,166, filed on Jan. 22, 2003.

(51) Int. Cl. B29C 35/08

(52) U.S. Cl. 264/400

(57) ABSTRACT

Embodiments of the present invention are directed to silicone based compositions having enhanced UV absorption, methods for making such compositions, methods of making electrochemical fabrication contact masks using such compositions, contact masks themselves, and electrochemical fabrication methods for using such masks. The enhanced UV absorption of the silicone allows it to be patterned by laser ablation. Some compositions include moieties having one or more aromatic rings attached to silicone backbones and molecules having ring structured polyimides with pluralities of double bond functional groups. Other compositions also include molecules having aromatic ring backbones and pluralities of double bond formation groups.

### RELATED APPLICATIONS

This application claims benefit to U.S. Provisional Patent Application No. 60/442,166, filed on Jan. 22, 2003. This application, including any appendices attached thereto is incorporated herein by reference as if set forth in full herein.

US GOVERNMENT RIGHTS

The invention(s) set forth herein were made with Government support under Contract Number DABT63-99-C-0042 awarded by DARPA. The Government has certain rights in the invention(s).

### FIELD OF THE INVENTION

Particular embodiments of the present application relate to compositions that are optically patternable, and more particularly to compositions that are optically patternable after formation and curing, e.g. by UV ablation of the composition. Other embodiments are directed to production of patterned masks using such compositions and the application of such masks to selective electrodeposition processes, e.g. electroplating processes where the patterned masks are used to limit the regions where deposition occurs. A selective deposition process that can take advantage of such masks is incorporated into a micro-scale or meso-scale device fabrication technology known as Electrochemical Fabrication (i.e. EFAB™).

### BACKGROUND OF THE INVENTION

A technique for forming three-dimensional structures (e.g. parts, components, devices, and the like) from a plurality of adhered layers was invented by Adam L. Cohen and is known as Electrochemical Fabrication. It is being commercially pursued by Microfabrica Inc. (formerly MEMGen® Corporation) of Burbank, Calif. under the name EFAB™. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of Microfabrica Inc. (formerly MEMGen® Corporation) of Burbank, Calif. such masks have come to be known as INSTANT MASKS™ and the process known as INSTANT MASKING™ or INSTANT MASK™ plating. Selective depositions using conformable contact mask plating may be used to form single layers of material or may be used to form multilayer structures. The teachings of the '630 patent are hereby incorporated herein by reference as if set forth in full herein. Since the filing of the patent application that led to the above noted patent, various papers about conformable contact mask plating (i.e. INSTANT MASKING) and electrochemical fabrication have been published:

(1) A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p161, August 1998;

(2) A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p244, January 1999;

(3) A. Cohen, “3-D Micromachining by Electrochemical Fabrication”, Micromachine Devices, March 1999;

(4) G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated MicroNanotechnology for Space Applications, The Aerospace Co., April 1999;

(5) F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999;

(6) A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999;

(7) F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November, 1999;

(8) A. Cohen, “Electrochemical Fabrication (EFAB™)”, Chapter 19 of The MEMS Handbook, edited by Mohamed Gad-El-Hak, CRC Press, 2002; and

(9) Microfabrication—Rapid Prototyping's Killer Application“, pages 1-5 of the Rapid Prototyping Report, CAD/CAM Publishing, Inc., June 1999;

The disclosures of these nine publications are hereby incorporated herein by reference as if set forth in full herein;

The electrochemical deposition process may be carried out in a number of different ways as set forth in the above patent and publications. In one form, this process involves the execution of three separate operations during the formation of each layer of the structure that is to be formed:

1. Selectively depositing at least one material by electrodeposition upon one or more desired regions of a substrate;

2. Then, blanket depositing at least one additional material by electrodeposition so that the additional deposit covers both the regions that were previously selectively deposited onto, and the regions of the substrate that did not receive any previously applied selective depositions; and

3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1(a)-1(c). FIG. 1(a) shows a side view of a CC mask 8 consisting of a conformable or deformable (e.g. elastomeric) insulator 10 patterned on an anode 12. The anode has two functions. FIG. 1(a) also depicts a substrate 6 separated from mask 8. One is as a supporting material for the patterned insulator 10 to maintain its integrity and alignment since the pattern may be topologically complex (e.g., involving isolated “islands” of insulator material). The other function is as an anode for the electroplating operation. CC mask plating selectively deposits material 22 onto a substrate 6 by simply pressing the insulator against the substrate then electrodepositing material through apertures 26a and 26b in the insulator as shown in FIG. 1(b). After deposition, the CC mask is separated, preferably non-destructively, from the substrate 6 as shown in FIG. 1(c). The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1(d)-1(f). FIG. 1(d) shows an anode 12′ separated from a mask 8′ that includes a patterned conformable material 10′ and a support structure 20. FIG. 1(d) also depicts substrate 6 separated from the mask 8′. FIG. 1(e) illustrates the mask 8′ being brought into contact with the substrate 6. FIG. 1(f) illustrates the deposit 22′ that results from conducting a current from the anode 12′ to the substrate 6. FIG. 1(g) illustrates the deposit 22′ on substrate 6 after separation from mask 8′. In this example, an appropriate electrolyte is located between the substrate 6 and the anode 12′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2(a)-2(f). These figures show that the process involves deposition of a first material 2 which is a sacrificial material and a second material 4 which is a structural material. The CC mask 8, in this example, includes a patterned conformable material (e.g. an elastomeric dielectric material) 10 and a support 12 which is made from deposition material 2. The conformal portion of the CC mask is pressed against substrate 6 with a plating solution 14 located within the openings 16 in the conformable material 10. An electric current, from power supply 18, is then passed through the plating solution 14 via (a) support 12 which doubles as an anode and (b) substrate 6 which doubles as a cathode. FIG. 2(a), illustrates that the passing of current causes material 2 within the plating solution and material 2 from the anode 12 to be selectively transferred to and plated on the cathode 6. After electroplating the first deposition material 2 onto the substrate 6 using CC mask 8, the CC mask 8 is removed as shown in FIG. 2(b). FIG. 2(c) depicts the second deposition material 4 as having been blanket-deposited (i.e. non-selectively deposited) over the previously deposited first deposition material 2 as well as over the other portions of the substrate 6. The blanket deposition occurs by electroplating from an anode (not shown), composed of the second material, through an appropriate plating solution (not shown), and to the cathode/substrate 6. The entire two-material layer is then planarized to achieve precise thickness and flatness as shown in FIG. 2(d). After repetition of this process for all layers, the multilayer structure 20 formed of the second material 4 (i.e. structural material) is embedded in first material 2 (i.e. sacrificial material) as shown in FIG. 2(e). The embedded structure is etched to yield the desired device, i.e. structure 20, as shown in FIG. 2(f).

Various components of an exemplary manual electrochemical fabrication system 32 are shown in FIGS. 3(a)-3(c). The system 32 consists of several subsystems 34, 36, 38, and 40. The substrate holding subsystem 34 is depicted in the upper portions of each of FIGS. 3(a) to 3(c) and includes several components: (1) a carrier 48, (2) a metal substrate 6 onto which the layers are deposited, and (3) a linear slide 42 capable of moving the substrate 6 up and down relative to the carrier 48 in response to drive force from actuator 44. Subsystem 34 also includes an indicator 46 for measuring differences in vertical position of the substrate which may be used in setting or determining layer thicknesses and/or deposition thicknesses. The subsystem 34 further includes feet 68 for carrier 48 which can be precisely mounted on subsystem 36.

The CC mask subsystem 36 shown in the lower portion of FIG. 3(a) includes several components: (1) a CC mask 8 that is actually made up of a number of CC masks (i.e. submasks) that share a common support/anode 12, (2) precision X-stage 54, (3) precision Y-stage 56, (4) frame 72 on which the feet 68 of subsystem 34 can mount, and (5) a tank 58 for containing the electrolyte 16. Subsystems 34 and 36 also include appropriate electrical connections (not shown) for connecting to an appropriate power source for driving the CC masking process.

The blanket deposition subsystem 38 is shown in the lower portion of FIG. 3(b) and includes several components: (1) an anode 62, (2) an electrolyte tank 64 for holding plating solution 66, and (3) frame 74 on which the feet 68 of subsystem 34 may sit. Subsystem 38 also includes appropriate electrical connections (not shown) for connecting the anode to an appropriate power supply for driving the blanket deposition process.

The planarization subsystem 40 is shown in the lower portion of FIG. 3(c) and includes a lapping plate 52 and associated motion and control systems (not shown) for planarizing the depositions.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers”. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer. The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation.

The '630 patent provides teachings concerning a number of different ways to create CC masks (i.e. electroplating articles). It teaches that masks may be made from patterned conformable material alone, patterned conformable material bonded to an anode material, or patterned conformable material bonded to a porous material. It teaches that useful masking compositions for conformable portions of the masks include elastomers such as, e.g., polydimethylsiloxane (i.e., silicone rubber) commercially available, e.g., under the trade designation Sylgard from Dow-Corning (e.g., Sylgard 182 and 184), and under the trade designation RMS-033 from Gelest. It further teaches that the masking compositions can include other additives, e.g., photoinitiators, fillers, and hydrogen getters.

Additionally the '630 patent teaches that the conformable material of a CC mask may be patterned by various molding operations. The molds may be formed in various ways including photolithographic selective exposure of and development of photoresists. It also indicates that the molds may also be formed from non-stick materials such as polytetrafluoroethylene or polypropylene and that they may include patterns made by reactive ion-etching or excimer ablations.

The '630 patent also teaches an alternative method of forming a CC mask that includes applying a layer of photopatternable liquid masking composition 146 in combination with a photoinitiator to a support and then the composition is exposed to patterned light (e.g., UV light transmitted through a photomask 162) to selectively cure the mask composition. The partially exposed composition is then developed to remove uncured masking composition.

The '630 patent also teaches the formation of a CC mask by applying a liquid masking composition (or a solid mask material) to a support, then curing the composition if necessary to form a solidified unpatterned mask then applying a photomask having light apertures over the composition and selectively exposing the solid composition to ultraviolet light having sufficient intensity and suitable wavelength for ablating the unpatterned mask to form a patterned mask after which the photomask is removed so as to form the electroplating article 172 (FIG. 8e).

Though the '630 patent teaches that silicone is useful material for the conformable portion of the CC masks, standard silicone compositions are not UV ablatable. Epoxies may be UV ablatable but are not typically conformable enough for use as conformable portions of a CC mask. Polyimides are UV ablatable but won't survive in typical plating baths and they typically swell such that their mechanical properties and the dimensional accuracy of any patterning are degraded. Urethanes are UV ablatable but won't survive in typical plating baths. Acrylics are UV ablatable but typically lack sufficient conformability.

Though the molding processes as taught in the '630 patent are effective in making masks, they are complex and include numerous process steps. Typically photomasks must be created, photoresists must be deposited, they must be exposed, they must be developed to create the mold, passivation may be required as well as steps to enhance the release properties of the mold, and then the mold must be used as a transfer pattern for creating a CC mask. Some or all of these steps may need to be performed in a clean room, they are performed in series, and the process is time consuming and labor intensive. After formation of the mask, additional plasma etching or the like may be required to ensure that intended openings in the mask are clear of masking material. Furthermore the equipment used in these processes may be costly.

As such a need remains in the art for enhanced mask making techniques that have the potential of simplifying the overall process, reducing cost associated with mask production, reducing labor requirements, reducing the time for mask production, and/or improving the reliability of the masks that are produced.

### SUMMARY OF THE INVENTION

In a first aspect of the invention a material includes a networked structure including the following moieties: a first moiety including at least one aromatic ring attached to a silicone backbone that possesses a plurality of SiH functional groups; and a second moiety including a ring structured polyimide with a plurality of double bond functional groups.

In a specific variation of this aspect, the networked structure includes a third moiety which includes an aromatic ring backbone with a plurality of double bond functional groups. In a further variation of this aspect the networked structure includes a fourth moiety which includes an aromatic ring backbone with a plurality of SiH functional groups.

In another specific variation of this aspect, the material includes a platinum catalyst. In other specific variations, the backbone of the first moiety includes at least two aromatic rings, the backbone of the third moiety includes at least two aromatic rings, and/or the backbone of the fourth moiety includes at least two aromatic rings. In still other specific variations, the aromatic rings are benzene rings. In a further variation, the double bond functional groups of the second moiety include vinyl functional groups.

In a second aspect of the invention a material includes a networked structure, including the following moieties: a moiety having a silicone backbone and a plurality of SiH functional groups and having a plurality of organic compatibility enhancing groups having structure R; and a flexible cyclic moiety having a plurality of double bond functional groups.

In a specific variation of this aspect, the networked structure further includes a moiety having a plurality of SiH functional groups and having a structure compatible with R. In a further variation of this aspect the networked structure includes a radiation absorbing moiety having a plurality of double bond functional groups and having a structure compatible with R.

In another specific variation of this aspect the material includes a platinum catalyst. In other specific variations of this aspect the moiety having a plurality of double bond functional groups and having a structure compatible with R includes a plurality of structures compatible with R. In still other specific variations of this aspect the material has properties of an elastomer. In a further variation the material is capable of being ablated using ultraviolet radiation.

In a third aspect of the invention a curable composition includes: a first component including molecules having at least one aromatic ring attached to a silicone backbone that possesses a plurality of SiH functional groups; a second component comprising molecules having a ring structured polyimide with a plurality of double bond functional groups; and a catalyst.

In a specific variation of this aspect, the composition further includes a third component including molecules having an aromatic ring backbone with a plurality of double bond functional groups. In a further variation, the composition includes a fourth component including molecules having an aromatic ring backbone with a plurality of SiH functional groups.

In an additional specific variation, the catalyst includes a platinum catalyst. In another specific variation, the backbone of the molecules of the first component include at least two aromatic rings, the backbone of the molecules of the third component include at least two aromatic rings, and/or the backbone of the fourth component includes at least two aromatic rings. In a further variation, the aromatic rings are benzene rings.

In still another specific variation of this aspect the double bond functional groups of the molecules of the second component include vinyl functional groups.

In a fourth aspect of the invention a curable composition includes: a component including molecules having a silicone backbone and a plurality of SiH functional groups and having a plurality of organic compatibility enhancing groups having structure R; a component including flexible cyclic molecules having a plurality of double bond functional groups; and a catalyst.

In a specific variation the composition further includes a component including molecules having a plurality of SiH functional groups and having a structure compatible with R.

In another specific variation the composition includes a component having radiation absorbing molecules with a plurality of double bond functional groups and having a structure compatible with R.

In an additional specific variation, the molecules having a plurality of double bond functional groups and having a structure compatible with R include a plurality of structures.

In a fifth aspect of the invention a method of forming a curable composition included: providing a first component including molecules having at least one aromatic ring attached to a silicone backbone that possesses a plurality of SiH functional groups; providing a second component including molecules having a ring structured polyimide with a plurality of double bond functional groups; providing a catalyst; mixing the components to achieve a substantially homogeneous solution; and mixing the catalyst with the substantially homogenous solution.

In a specific variation of this aspect, the method further includes providing a third component including molecules having an aromatic ring backbone with a plurality of double bond functional groups. In a further specific variation of this aspect the method further includes providing a fourth component including molecules having an aromatic ring backbone with a plurality of SiH functional groups.

In a sixth aspect of the invention a method of forming a curable composition includes: providing a first component including molecules having a silicone backbone and a plurality of SiH functional groups and having a plurality of organic compatibility enhancing groups having structure R; providing a second component including flexible cyclic molecules having a plurality of double bond functional groups; providing a catalyst; mixing the components to achieve a substantially homogeneous solution; and mixing the catalyst with the substantially homogenous solution.

A specific variation of this aspect provides a component including molecules having a plurality of SiH functional groups and having a structure compatible with R. In a further variation of this aspect a component is provided that includes radiation absorbing molecules having a plurality of double bond functional groups and having a structure compatible with R.

In a seventh aspect of the invention a conformable contact mask includes: applying a liquid composition to a support structure, the liquid composition being applied such that the composition has a desired thickness over the support structure; curing the composition to form a solidified and flexible member on the support structure; laser ablating a selected portion of the flexible member, to form a mask having a desired pattern, the pattern including at least one opening extending through the flexible member; wherein the liquid composition includes: a first component including molecules having at least one aromatic ring attached to a silicone backbone that possesses a plurality of SiH functional groups; a second component including molecules having a ring structured polyimide with a plurality of double bond functional groups; and a catalyst.

In a specific variation of this aspect the liquid composition additionally includes a third component including molecules having an aromatic ring backbone with a plurality of double bond functional groups. In a further variation of this aspect the liquid composition additionally includes a fourth component including molecules having an aromatic ring backbone with a plurality of SiH functional groups.

In an eighth aspect of the invention a conformable contact mask includes: applying a liquid composition to a support structure, the liquid composition being applied such that the composition has a desired thickness over the support structure; curing the composition to form a solidified and flexible member on the support structure; laser ablating a selected portion of the flexible member, to form a mask having a desired pattern, the pattern including at least one opening that extends through the flexible member; wherein the liquid composition includes: a first component including molecules having a silicone backbone and a plurality of SiH functional groups and having a plurality of organic compatibility enhancing groups having structure R; a second component including flexible cyclic molecules having a plurality of double bond functional groups, and a catalyst.

In a specific variation of this aspect a third component includes molecules having a plurality of SiH functional groups and having a structure compatible with R. In a further variation of this aspect a fourth component includes radiation absorbing molecules having a plurality of double bond functional groups and having a structure compatible with R.

In a ninth aspect of the invention a conformable contact mask includes: providing a cured sheet of conformable material having a desired thickness; bonding the sheet of conformable material to a support structure; laser ablating a selected portion of the flexible member, to form a mask having a desired pattern, the pattern including at least one opening extending through the flexible member; wherein the conformable material includes: a first component including molecules having at least one aromatic ring attached to a silicone backbone that possesses a plurality of SiH functional groups; and a second component including molecules having a ring structured polyimide with a plurality of double bond functional groups.

In a specific variation of this aspect the liquid composition additionally includes a third component including molecules having an aromatic ring backbone with a plurality of double bond functional groups. In a further variation of this aspect the liquid composition additionally includes a fourth component including molecules having an aromatic ring backbone with a plurality of SiH functional groups.

In a tenth aspect of the invention a conformable contact mask, includes: providing a cured sheet of conformable material having a desired thickness; bonding the sheet of conformable material to a support structure; laser ablating a selected portion of the flexible member, to form a mask having a desired pattern, the pattern including at least one opening that extends through the flexible member; wherein the liquid composition includes: a first component including molecules having a silicone backbone and a plurality of SiH functional groups and having a plurality of organic compatibility enhancing groups having structure R; and a second component including flexible cyclic molecules having a plurality of double bond functional groups.

In a specific variation of this aspect a third component includes molecules having a plurality of SiH functional groups and having a structure compatible with R. In a further variation of this aspect a fourth component includes radiation absorbing molecules having a plurality of double bond functional groups and having a structure compatible with R.

In an eleventh aspect of the invention a conformable contact masking method of producing a structure includes: supplying at least one preformed mask including a patterned conformable dielectric material that includes at least one opening through which deposition can take place during the formation of at least a portion of a layer of the structure, and wherein the at least one mask includes a support structure that supports the patterned conformable dielectric material, wherein the conformable material is patterned, at least in part, by ablating material using electromagnetic radiation, and wherein the conformable dielectric material includes a networked structure including at least the following moieties: a first moiety including at least one aromatic ring attached to a silicone backbone that possesses a plurality of SiH functional groups; a second moiety including a ring structured polyimide with a plurality of double bond functional groups; and selectively depositing at least a portion of a layer onto a substrate, including: contacting the substrate and the conformable material of the preformed mask; in presence of a plating solution, applying a desired electrical activation to an electrode and to the substrate, so as to either (a) deposit a selected material onto the substrate through the at least one opening, or (b) etch material from the substrate to form a void in the substrate and thereafter to at least partially fill in the void by depositing a selected material to form at least a portion of a layer; and separating the selected preformed mask from the substrate.

In a specific variation of this aspect the networked structure additionally includes a third moiety including an aromatic ring backbone with a plurality of double bond functional groups. In a further variation of this aspect the networked structure additionally includes a fourth moiety including an aromatic ring backbone with a plurality of SiH functional groups.

In a twelfth aspect of the invention a conformable contact masking method of producing a structure includes: supplying at least one preformed mask including a patterned conformable dielectric material that includes at least one opening through which deposition can take place during the formation of at least a portion of a layer of the structure, and wherein the at least one mask includes a support structure that supports the patterned conformable dielectric material, wherein the conformable material is patterned, at least in part, by ablating material using electromagnetic radiation, and wherein the conformable dielectric material includes a networked structure including at least the following moieties: a first moiety having a silicone backbone and a plurality of SiH functional groups and having a plurality of organic compatibility enhancing groups having structure R; a second flexible cyclic moiety having a plurality of double bond functional groups; selectively depositing at least a portion of a layer onto a substrate, including: contacting the substrate and the conformable material of the preformed mask; in presence of a plating solution, applying a desired electrical activation to an electrode and to the substrate, so as to either (a) deposit a selected material onto the substrate through the at least one opening, or (b) etch material from the substrate to form a void in the substrate and thereafter to at least partially fill in the void by depositing a selected material to form at least a portion of a layer; and separating the selected preformed mask from the substrate.

In a specific variation of this aspect the networked structure further includes a moiety having a plurality of SiH functional groups and having a structure compatible with R. In a further variation of this aspect the networked structure additionally includes a radiation absorbing moiety having a plurality of double bond functional groups and having a structure compatible with R.

In a thirteenth aspect of the invention a multilayer three-dimensional structure is formed, including: (a) forming a layer of at least one material on a substrate that may include one or more previously deposited layers of one or more materials; (b) repeating the forming operation of “(a)” one or more times to form at least one subsequent layer on at least one previously formed layer to build up a three-dimensional structure from a plurality layers; wherein the forming of at least one layer, includes: (1) supplying a substrate on which one or more successive depositions of one or more materials may have occurred; (2) supplying a mask having a pattern of dielectric material for proximate or contact positioning relative to the substrate, the pattern of dielectric material defining a pattern having at least one opening in the dielectric material; (3) bringing the mask and the substrate into proximate positioning or contact such that the pattern having at least one opening in the dielectric material has a desired registration with respect to any previous depositions of material and providing a desired electrolyte solution such that the solution is located within the openings; (4) applying a desired electrical activation to an electrode and to the substrate, so as to either (a) deposit a material onto the substrate through the at least one opening, or (b) etch material from the substrate to form a void in the substrate and thereafter to at least partially fill in the void by depositing a selected material; wherein the conformable dielectric material includes a networked structure including at least the following moieties: a first moiety including at least one aromatic ring attached to a silicone backbone that possesses a plurality of SiH functional groups; and a second moiety including a ring structured polyimide with a plurality of double bond functional groups.

In a specific variation of this aspect the networked structure additionally includes a third moiety including an aromatic ring backbone with a plurality of double bond functional groups. In a further variation of this aspect the networked structure additionally includes a fourth moiety including an aromatic ring backbone with a plurality of SiH functional groups.

In a fourteenth aspect of the invention a multilayer three-dimensional structure is formed, including: (a) forming a layer of at least one material on a substrate that may include one or more previously deposited layers of one or more materials; (b) repeating the forming operation of “(a)” one or more times to form at least one subsequent layer on at least one previously formed layer to build up a three-dimensional structure from a plurality layers; wherein the forming of at least one layer, includes: (1) supplying a substrate on which one or more successive depositions of one or more materials may have occurred; (2) supplying a mask having a pattern of dielectric material for proximate or contact positioning relative to the substrate, the pattern of dielectric material defining a pattern having at least one opening in the dielectric material; (3) bringing the mask and the substrate into proximate positioning or contact such that the pattern having at least one opening in the dielectric material has a desired registration with respect to any previous depositions of material and providing a desired electrolyte solution such that the solution is located within the openings; (4) applying a desired electrical activation to an electrode and to the substrate, so as to either (a) deposit a material onto the substrate through the at least one opening, or (b) etch material from the substrate to form a void in the substrate and thereafter to at least partially fill in the void by depositing a selected material; wherein the conformable dielectric material includes a networked structure including at least the following moieties: a first moiety having a silicone backbone and a plurality of SiH functional groups and having a plurality of organic compatibility enhancing groups having structure R; a second flexible cyclic moiety having a plurality of double bond functional groups.

In a specific variation of this aspect the networked structure further includes a moiety having a plurality of SiH functional groups and having a structure compatible with R. In a further variation of this aspect the networked structure additionally includes a radiation absorbing moiety having a plurality of double bond functional groups and having a structure compatible with R.

In a fifteenth aspect of the invention a material includes a networked structure including the following moieties: a first moiety including at least one aromatic ring attached to a silicone backbone that possesses a plurality of SiH functional groups and a second moiety including an aromatic ring backbone with a plurality of SiH functional groups.

In a sixteenth aspect of the invention a material includes a networked structure including the following moieties: a first moiety having a silicone backbone and a plurality of SiH functional groups and having a plurality of organic compatibility enhancing groups having structure R; a radiation absorbing moiety having a plurality of double bond functional groups and having a structure compatible with R.

In a seventeenth aspect of the invention a material includes a networked structure including the following moieties: a first moiety including an aromatic ring backbone with a plurality of double bond functional groups and a second moiety including a ring structured polyimide with a plurality of double bond functional groups.

In an eighteenth aspect of the invention a material includes a networked structure including the following moieties: a moiety having a plurality of SiH functional groups and having a structure compatible with R; and a flexible cyclic moiety having a plurality of double bond functional groups.

In a nineteenth aspect of the invention a curable composition includes a first component including molecules having at least one aromatic ring attached to a silicone backbone that possesses a plurality of SiH functional groups; a second component including molecules having an aromatic ring backbone with a plurality of SiH functional groups; and a catalyst.

In a twentieth aspect of the invention a curable composition includes (a) a component including molecules having a silicone backbone and a plurality of SiH functional groups and having a plurality of organic compatibility enhancing groups having structure R; (b) a component including radiation absorbing molecules having a plurality of double bond functional groups and having a structure compatible with R; and (c) a catalyst.

In a twenty-first aspect of the invention a curable composition includes a first component including molecules having an aromatic ring backbone with a plurality of double bond functional groups; a fourth component including molecules having a ring structured polyimide with a plurality of double bond functional groups; and a catalyst.

In a twenty-second aspect of the invention a curable composition includes (a) a component that includes molecules having a plurality of SiH functional groups and having a structure compatible with R; (b) a component including flexible cyclic molecules having a plurality of double bond functional groups; and (c) a catalyst.

In a twenty-third aspect of the invention a method for forming a curable composition includes (a) providing a first component including molecules having at least one aromatic ring attached to a silicone backbone that possesses a plurality of SiH functional groups; (b) providing a second component including molecules having an aromatic ring backbone with a plurality of SiH functional groups; (c) providing a catalyst; (d) mixing the components to achieve a substantially homogeneous solution; and (e) mixing the catalyst with the substantially homogenous solution.

In a twenty-fourth aspect of the invention a method for forming a curable composition includes (a) providing a first component including molecules having a silicone backbone that possesses a plurality of organic compatibility enhancing groups having structure R; (b) providing a second component including molecules having a radiation absorbing moiety having a plurality of double bond functional groups and having a structure compatible with R; (c) providing a catalyst; (d) mixing the components to achieve a substantially homogeneous solution; and (e) mixing the catalyst with the substantially homogenous solution.

In a twenty-fifth aspect of the invention a method for forming a curable composition includes (a) providing a first component including molecules having an aromatic ring backbone with a plurality of double bond functional groups; (b) providing a second component including molecules having a ring structured polyimide with a plurality of double bond functional groups; (c) providing a catalyst; (d) mixing the components to achieve a substantially homogeneous solution; and (e) mixing the catalyst with the substantially homogenous solution.

In a twenty-sixth aspect of the invention a method for forming a curable composition includes (a) providing a first component including molecules having a plurality of SiH functional groups and having a structure compatible with R; (b) providing a second component including molecules having a flexible cyclic moiety having a plurality of double bond functional groups; (c) providing a catalyst; (d) mixing the components to achieve a substantially homogeneous solution; and (e)mixing the catalyst with the substantially homogenous solution.

In a twenty-seventh aspect of the invention a curable composition includes: providing a first component including molecules having at least one aromatic ring attached to a silicone backbone that possesses a plurality of SiH functional groups; providing a second component including molecules having a ring structured polyimide with a plurality of double bond functional groups; providing a catalyst; mixing the components and the catalyst.

In a twenty-eighth aspect of the invention a curable composition includes: providing a first component including molecules having a silicone backbone and a plurality of SiH functional groups and having a plurality of organic compatibility enhancing groups having structure R; providing a second component including flexible cyclic molecules having a plurality of double bond functional groups; providing a catalyst; mixing the components and the catalyst.

In a twenty-ninth aspect of the invention a method for forming a curable composition includes (a) providing a first component including molecules having at least one aromatic ring attached to a silicone backbone that possesses a plurality of SiH functional groups; (b) providing a second component including molecules having an aromatic ring backbone with a plurality of SiH functional groups; (c) providing a catalyst; (d) mixing the components and the catalyst.

In a thirtieth aspect of the invention a method for forming a curable composition includes (a) providing a first component including molecules having a silicone backbone that possesses a plurality of organic compatibility enhancing groups having structure R; (b) providing a second component including molecules having a radiation absorbing moiety having a plurality of double bond functional groups and having a structure compatible with R; (c) providing a catalyst; (d) mixing the components and the catalyst.

In a thirty-first aspect of the invention a method for forming a curable composition includes (a) providing a first component including molecules having a plurality of SiH functional groups and having a structure compatible with R; (b) providing a second component including molecules having a flexible cyclic moiety having a plurality of double bond functional groups; (c) providing a catalyst; (d) mixing the components and the catalyst.

In a thirty-second aspect of the invention a method for forming a curable composition includes (a) providing a first component including molecules having a plurality of SiH functional groups and having a structure compatible with R; (b) providing a second component including molecules having a flexible cyclic moiety having a plurality of double bond functional groups; (c) providing a catalyst; (d) mixing the components and the catalyst.

Further aspects of the invention will be understood by those of skill in the art upon reviewing the teachings herein. Other aspects of the invention may involve combinations of the above noted aspects of the invention. Other aspects of the invention may involve apparatus that can be used in implementing one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1(a)-1(c) schematically depict side views of various stages of a CC mask plating process, while FIGS. 1(d)-(g) schematically depict a side views of various stages of a CC mask plating process using a different type of CC mask.

FIGS. 2(a)-2(f) schematically depict side views of various stages of an electrochemical fabrication process as applied to the formation of a particular structure where a sacrificial material is selectively deposited while a structural material is blanket deposited.

FIGS. 3(a)-3(c) schematically depict side views of various example subassemblies that may be used in manually implementing the electrochemical fabrication method depicted in FIGS. 2(a)-2(f).

FIGS. 4(a)-4(i) schematically depict the formation of a first layer of a structure using adhered mask plating where the blanket deposition of a second material overlays both the openings between deposition locations of a first material and the first material itself.

FIG. 5 provides a schematic illustration of the potential components of a material where a portion of the components combine together to form a network structure while the other components may be fixed in place by the network but do not become part of it.

FIG. 6 provides a schematic illustration of one method of producing a curable material.

FIG. 7 provides a schematic illustration of an alternative method for forming a curable composition.

FIGS. 8(a)-8(e) provide schematic illustrations of side views of various steps in the formation of a mask by oblation.

### DETAILED DESCRIPTION OF PREFERRED EMBODIMENTS

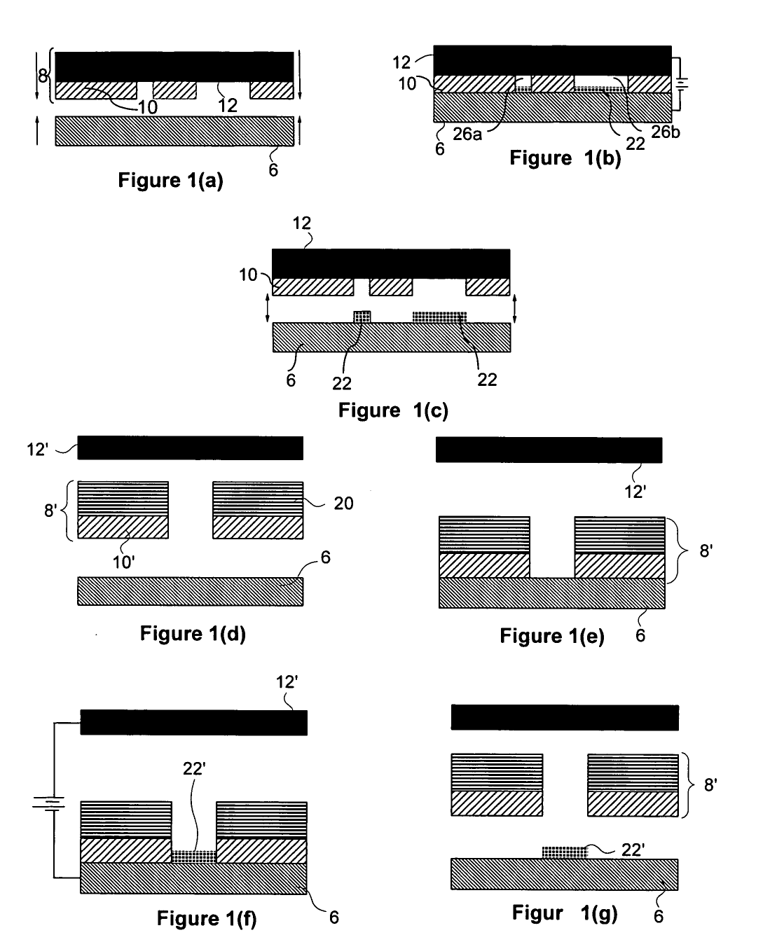

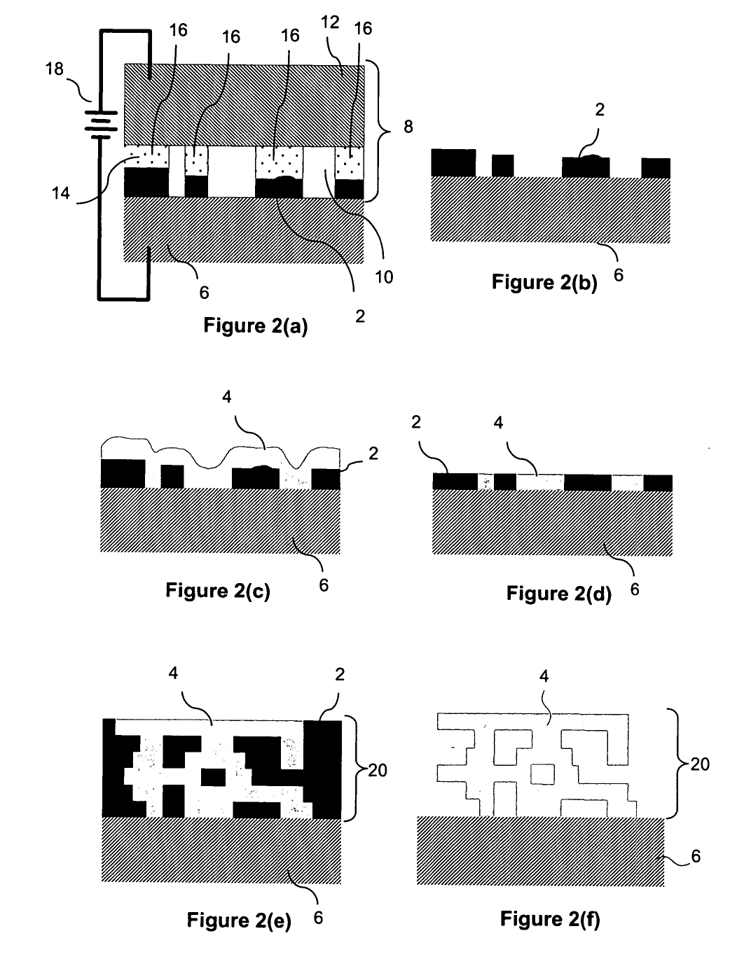

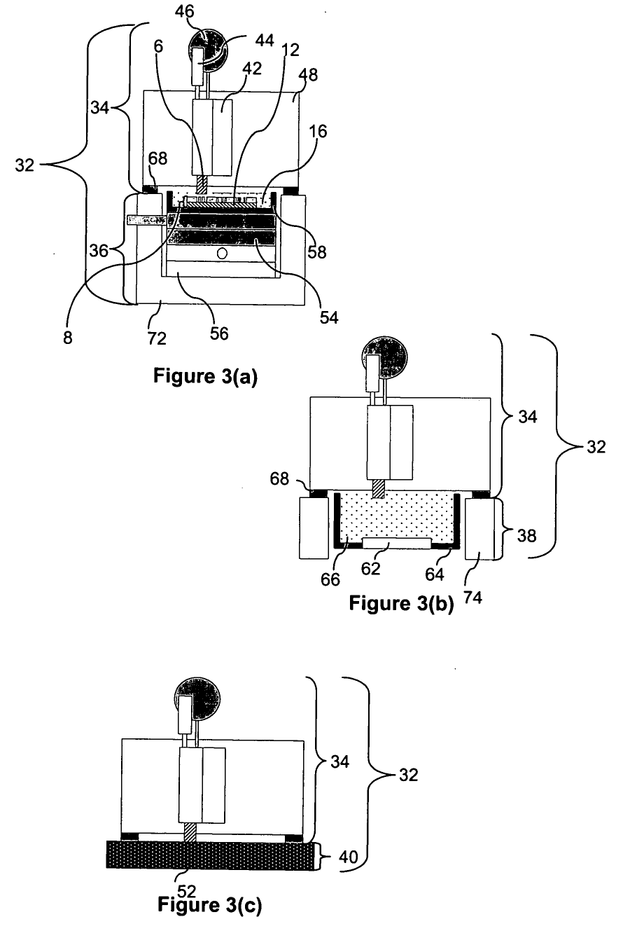

FIGS. 1(a)-1(g), 2(a)-2(f), and 3(a)-3(c) illustrate various features of one form of electrochemical fabrication that are known. Other electrochemical fabrication techniques are set forth in the '630 patent referenced above, in the various previously incorporated publications, in various other patents and patent applications incorporated herein by reference, still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments may be derived from combinations of the various embodiments explicitly set forth herein.

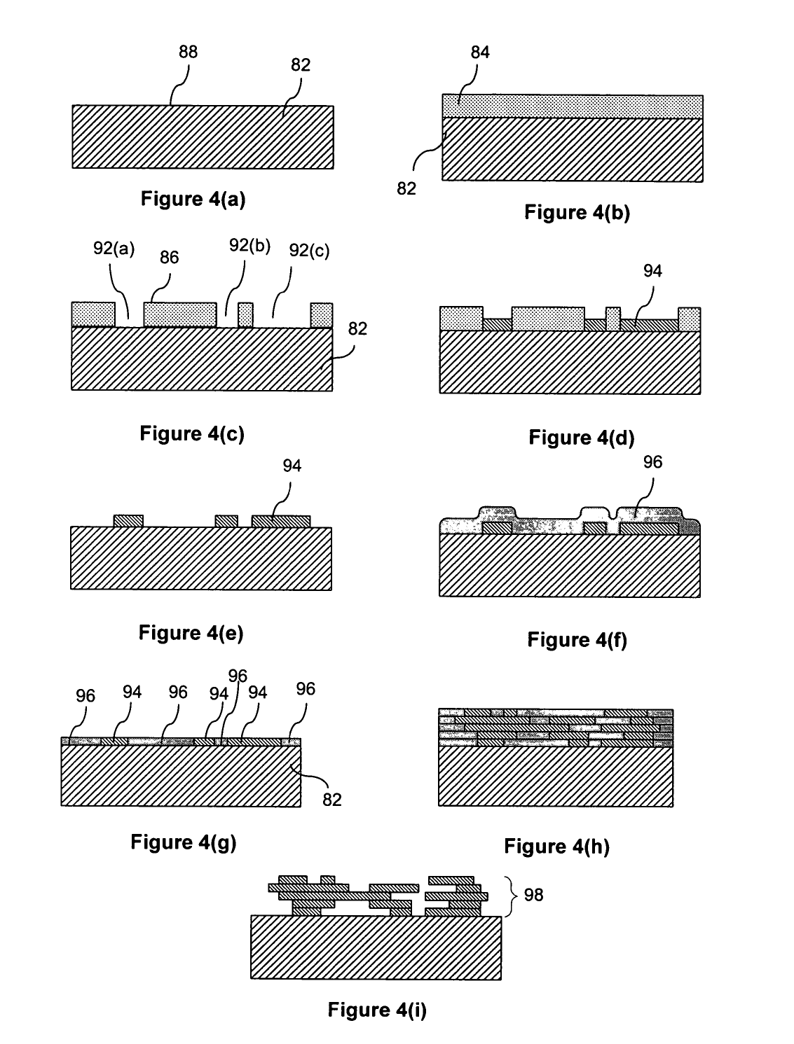

FIGS. 4(a)-4(i) illustrate various stages in the formation of a single layer of a multilayer fabrication process where a second metal is deposited on a first metal as well as in openings in the first metal where its deposition forms part of the layer. In FIG. 4(a), a side view of a substrate 82 is shown, onto which patternable photoresist 84 is cast as shown in FIG. 4(b). In FIG. 4(c), a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4(d), a metal 94 (e.g. nickel) is shown as having been electroplated into the openings 92(a)-92(c). In FIG. 4(e), the photoresist has been removed (i.e. chemically stripped) from the substrate to expose regions of the substrate 82 which are not covered with the first metal 94. In FIG. 4(f), a second metal 96 (e.g., silver) is shown as having been blanket electroplated over the entire exposed portions of the substrate 82 (which is conductive) and over the first metal 94 (which is also conductive). FIG. 4(g) depicts the completed first layer of the structure which has resulted from the planarization of the first and second metals down to a height that exposes the first metal and sets a thickness for the first layer. In FIG. 4(h) the result of repeating the process steps shown in FIGS. 4(b)-4(g) several times to form a multilayer structure are shown where each layer consists of two materials. For most applications, one of these materials is removed as shown in FIG. 4(i) to yield a desired 3-D structure 98 (e.g. component or device).

The some embodiments, alternatives, and techniques disclosed herein may form multilayer structures using a single patterning technique on all layers or using different patterning techniques on different layers. For example, different types of patterning masks and masking techniques may be used or even techniques that perform direct selective depositions without the need for masking may be used. For example, conformable contact masks formed using an ablatable silicone material may be used in combination with conformable contact masks formed from other materials and/or non-conformable contact masks and masking operations on some layers while other layers may be formed using other mask types or using contact masks without the modified mating techniques. Proximity masks and masking operations (i.e. operations that use masks that at least partially selectively shield a substrate by their proximity to the substrate even if contact is not made) may be used during the formation of some layers. Adhered masks and masking operations (masks and operations that use masks that are adhered to a substrate onto which selective deposition or etching is to occur as opposed to only being contacted to it) may be used during the formation of some layers. In still other embodiments where multiple selective patterning operations are used on a single layer, those multiple operations may be performed using the same or different patterning techniques.

In the first preferred embodiment a laser ablatable material (e.g. ablatable by 248 nanometer radiation) is provided. This material includes two primary components or moieties that at least in part make up a networked structure. The first moiety includes at least one aromatic ring attached to a silicone backbone that posses a plurality of SiH functional groups. Examples of such molecules include HPM502 from Gelest Inc. and PS129.5 from United Chemical Technologies which are methylhydrosiloxane-phenylmethylsiloxane copolymer, hydride terminated having CAS: 115487-49-5. The second component or moiety is a ring structured polyimide with the plurality of double bond functional groups. An example of such a material is Trially-1,3,5-triazine-2,4,6-(1H, 3H, 5H)-trione (this is called triene in TABLE 1, below). Such material is available from General Electric as part number RTV665A/B. In forming the networked material of this first embodiment a platinum catalyst may be used to lower the curing temperature or to increase the reaction rate. Effective relative amounts of these first and second moieties may be combined to yield materials of desired properties. These effective amounts and ranges thereof may be readily experimentally determined without undue experimentation by those of skill in the art.

A second embodiment provides a material having a networked structure where two of the components are the same as that of the first embodiment and where a third component is added which provides an aromatic ring backbone having a plurality of double bond functional groups. Examples of such components include bisphenyl A structures such as diallylether bisphenol or phenyl backboned Si—H[(p-dimethysilyl)phenyl] ether (noted as hsiether in TABLE 1). Effective relative amounts of these first to third moieties may be combined to yield materials of desired properties. These effective amounts and ranges thereof may be readily experimentally determined without undue experimentation by those of skill in the art.

A third preferred embodiment provides the material similar to those of the first and second embodiments with the exception that a fourth component is added. The fourth component provides an aromatic ring backbone with a plurality of SiH functional groups such as Si—H, Bis[(p-dimethysilyl) phenyl]ether. Effective relative amounts of these first to fourth moieties may be combined to yield materials of desired properties. These effective amounts and ranges thereof may be readily experimentally determined without undue experimentation by those of skill in the art.

The materials of the first three embodiments may have particular uses such as conformable materials forming part of conformable contact masks used in electrochemical fabrication where the material of the first embodiment forms a very weak conformable material. The material of the second embodiment forms a stronger but still soft material while the material of the third embodiment is harder yet.

A fourth embodiment provides a material that includes the first component of the first embodiment and the fourth component of the third embodiment. Materials of this type are even more rigid than the materials of the third embodiment but they still may be functional as mating materials for conformable contact masks. These materials tend to cure more rapidly than the materials of the first three embodiments and may be useful in various epoxy-type applications. Effective relative amounts of these moieties may be combined to yield materials of desired properties. These effective amounts and ranges thereof may be readily experimentally determined without undue experimentation by those of skill in the art.

A fifth embodiment provides a material that includes the second component of the first embodiment and the third component added by the second embodiment. Materials of this embodiment tend to act like hot melt adhesives and may be useful in such applications. Effective relative amounts of these moieties may be combined to yield materials of desired properties. These effective amounts and ranges thereof may be readily experimentally determined without undue experimentation by those of skill in the art.

Other embodiments of the invention may provide additional components to the first to fifth embodiments. These additional components may involve moieties that form part of the network structure or alternatively they may involve components that are simply surrounded by the network structure. As already mentioned such components may include a catalyst such as a platinum catalyst. Examples of such a catalysts include PC073 from Fluorochem of Derbyshire, UK which contains about 1% platinum and is in a xylene carrier and PC076 which contains 1% platinum and is in a Silicone carrier. Other example catalysts may include hydrogen hexachloroplatinate hydrate, H2PtCl₆—H2O, in a solvent of 2-ethyl-1-hexanol, for example, these components may be mixed at 0.04 grams to 15 grams and then diluted to a 0.1% solution (Platinum Solution #1 in TABLE 1. As a second example, PC073 may be diluted with the hydrogen hexachloroplatinate hydrate solvent at a ratio of one to nine (Platinum solution #2 in TABLE 1). Other components may be used to modify physical properties of the bulk structure or surface properties of the structure. Effective relative amounts of these moieties and possibly one or more components may be combined to yield materials of desired properties (e.g. laser ablatable materials). These effective amounts and ranges thereof may be readily experimentally determined without undue experimentation by those of skill in the art.

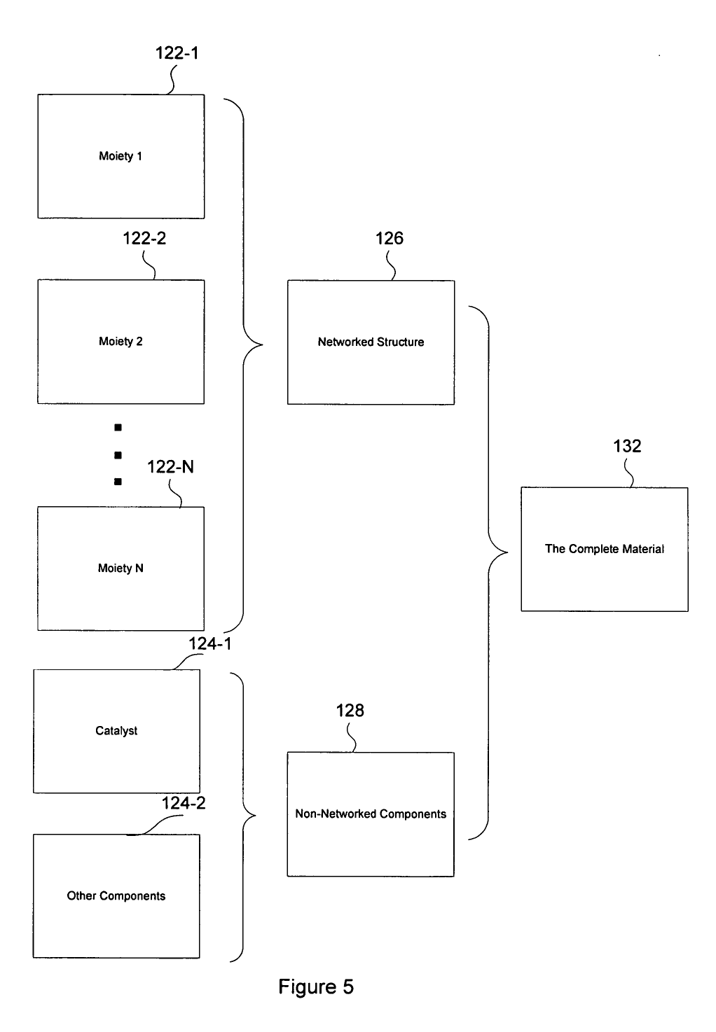

FIG. 5 illustrates that in some embodiments a completed material 132 may involve a networked structure 126 as well as other non-networked components 128 and that the network structure may involve a number of different moieties 122-1, 122-2, through 122-N. The Non-networked components may involve one or more components 124-1 and 124-2, for example. Additional embodiments of the invention provide curable compositions that may have components or moieties similar to those of the first to fifth embodiments. These components or moieties may be mixed together to form a homogeneous solution. A catalyst may then be added and the combination mixed together. Such curable compositions may be used in a variety of applications including methods for forming conformable contact masks.

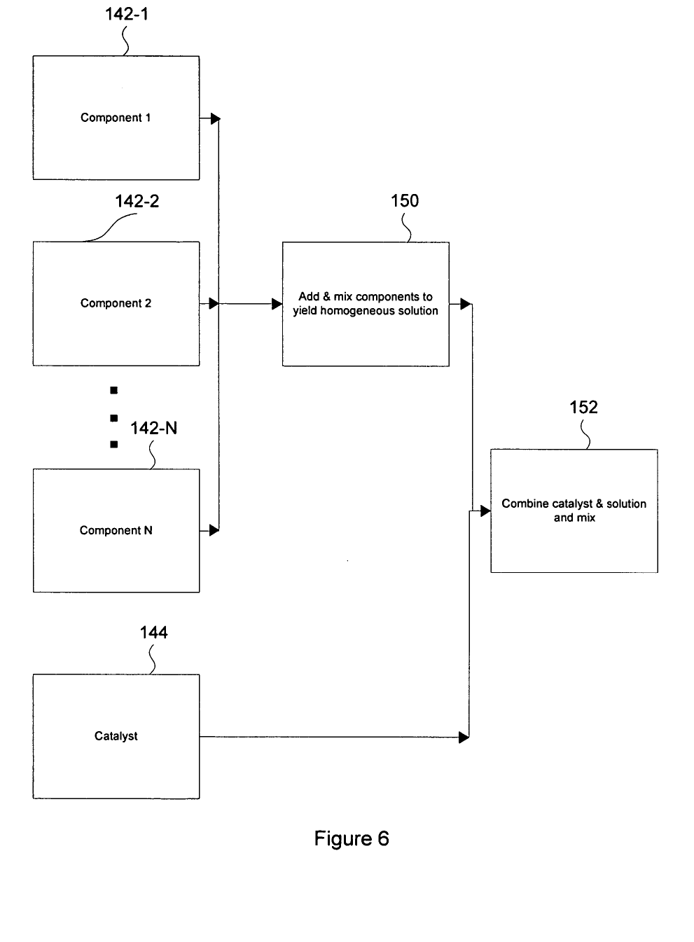

FIG. 6 illustrates a process for forming such a composition. Components 142-1, 142-2 through 142-N are mixed together to yield a homogeneous solutions as indicted in Block 150. Then the solution is mixed with the catalyst of Block 144 as indicated in block 152 to yield a final composition

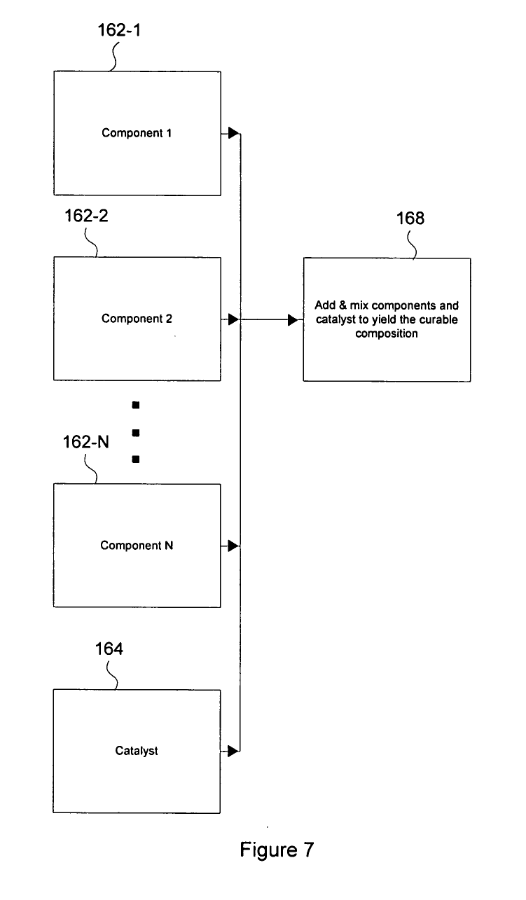

FIG. 7 illustrates an alternative process where all of the components 162-1, 162-2, 162-N, and a catalyst 164 are mixed simultaneously to yield the curable composition 168.

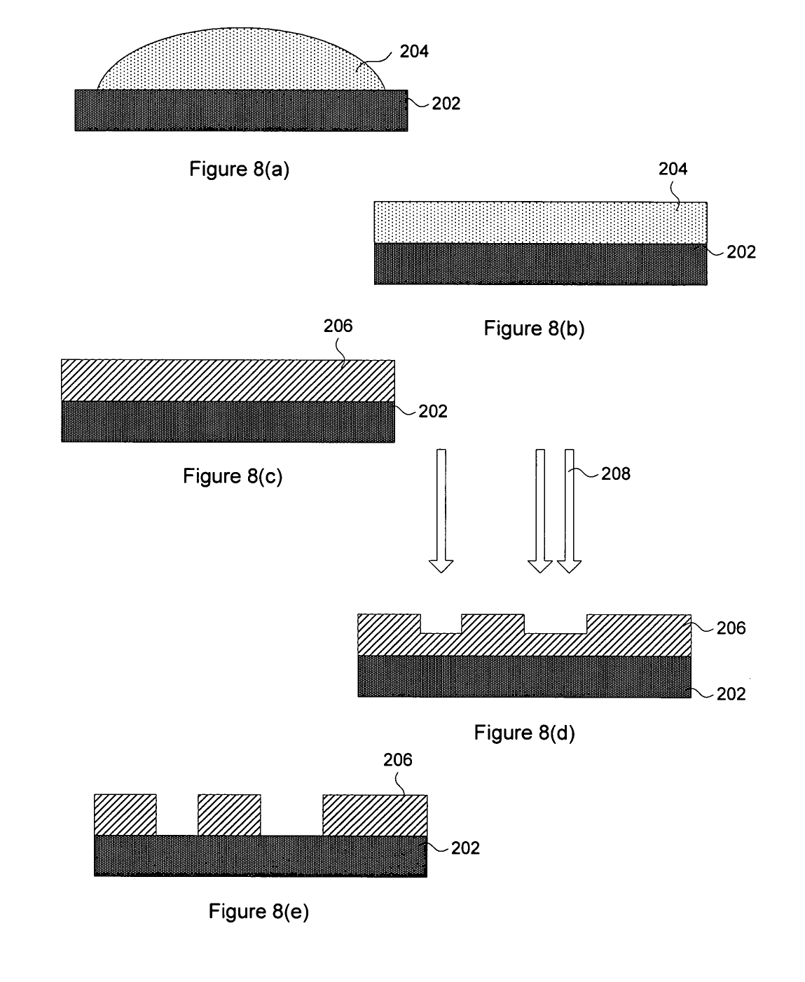

FIGS. 8(a)-8(e) provide schematic illustrations of exemplary side views of various steps that may be used in the formation of a mask by ablation. FIG. 8(a) depicts a support 202 onto which, curable composition 204 is deposited. Through the deposition process or through a supplemental process the thickness of curable material 204 is made uniform and set to a desired amount as shown in FIG. 8(b). FIG. 8(c) illustrates the transformation of curable material 204 into solidified material 206, for example by curing at an elevated temperature. The solidified material preferably has desired properties, e.g. when used as a contact mask material for some plating solutions, like copper pyrophosphate solutions, the following properties may be useful: (1) a desired elasticity so that it may be repeatedly used; (2) a desired hardness, e.g. a shore hardness of about 30-70, more preferably about 40-60, and most preferably about 45-55; (3) a desired cure temperature, e.g. less than 100° C., more preferably less than about 85-90° C., and more preferably less than or equal to about 70-80° C.; (4) a desired chemical resistance and hydrostability can tolerate P₂O₇, copper pyrophosphate, NH₃, a pH in the 7-8 to 10 range; (5) a desired level of adhesion to an instant mask substrate or support material, e.g. Si Cu, Ni SiO_{2; (}6) it should be a strong absorber of ablating radiation (e.g. UVR in the range of 157-308 nm) with the substrate, and the like. FIG. 8(d) illustrates the ablation of a portion of material 206 via UV radiation that is selectively applied to material 206. The selective application of UV radiation may occur via a blanket exposure applied to a mask that is located above material 206 or alternatively it may be applied in the form of a beam which is selectively scanned relative to material 206 such that the beam strikes desired locations of the material for a sufficient time to cause ablation of material 206 down to support 202. The resulting mask of this example is shown in FIG. 8(e) with material 206 patterned to a desired shape. The ablation may occur by exposing the material to radiation from an Excimer laser (e.g. 248 nm radiation) or from an Ultrafast laser.

In still other embodiments the first to fourth components mentioned with regard to the first to fifth embodiments may be respectively replaced by (1) a moiety or a component having a silicon backbone and a plurality of SiH functional groups and having a plurality of organic compatibility enhancing groups that have a structure R, (2) a moiety or component having a plurality of SiH functional groups and having a structure compatible with R, (3) a moiety or component having a radiation absorbing structure that includes a plurality of double bond functional groups and that has a structure compatible with R, and (4) a moiety or component having a flexible cyclic structure, and having a plurality of having double bond functional groups. The structure R in these alternative embodiments may take on various forms. For example R may have a methyl structure, a phenyl structure or may simply be a hydrogen atom. Effective relative amounts of these components or moieties may be combined to yield materials of desired properties. These effective amounts and ranges thereof may be readily experimentally determined without undue experimentation by those of skill in the art.

In some embodiments of the invention, liquid compositions may be cured after blanket or patterned deposition or molding operations, via, for example, time, heat and time (e.g. temperature elevated to 65° C. for a few hours to a few days), or the like. In some case radiation may be used to aid the curing process.

Some examples of components of compositions according to some embodiments of the invention are set forth in TABLE 1 below. In TABLE 1, components 1-9 refer to (1) Copolymers HPM 502 or PS129.5, (2) Triene, (3) Platinum Solution #1, (4) HSiether, (5) Platinum Solution PC076, (6) PS 537 (dimethyl Silicone), (7) Platinum Solution PC073, (8) diallyletherBA, and (9) Platinum Solution 2. Component values are specified in grams, and hardness is specified as Shore A.

TABLE 1

| Component/ | | | | | | | | | | |
|---|---|---|---|---|---|---|---|---|---|---|
| Composition | 1 | 2 | 3 | 4 | 5 | 6 | 7 | 8 | 9 | Hardness |
| Example 1 | 5 | | | | | | 0.047 | 2.82 | | 65-70 |
| Example 2 | 4.17 | | | 1.22 | 0.049 | | | 2.82 | | 48 |
| Example 3 | 4.17 | | | | 0.052 | 1.704 | | 2.82 | | 40 |
| Example 4 | 4.17 | | | 1.22 | | | | 2.82 | 0.049 | 50 |
| Example 5 | 4.17 | | | 1.22 | | | 0.02 | 2.82 | | 50 |
| Example 6 | 4.17 | | | | | 1.7 | 0.02 | 2.82 | | 50-55 |
| Example 7 | 4.17 | | | 0.61 | | 0.85 | 0.02 | 2.82 | | 50 |
| Example 8 | 2.5 | 0.2 | | 0.6 | | | 0.06 | 3.5 | | 55-60 |
| Example 9 | 2.5 | 0.2 | | 0.6 | | | 0.06 | 3.5 | | 55 |
| Example 10 | 2.5 | 0.4 | | 0.6 | | | 0.06 | 3.5 | | 55-60 |
| Example 11 | 2.5 | 0.2 | | | | | 0.02 | 3.5 | | 60 |
| Example 12 | 2.25 | 0.38 | | 0.6 | | | 0.06 | 3.5 | | 50 |
| Example 13 | 2 | 0.2 | | 0.6 | | | 0.06 | 3.5 | | 50 |
| Example 14 | 5 | 2.77 | 0.2 | | | | | | | 30-40 |
| Example 15 | 2.5 | 2.36 | 0.2 | 2.5 | | | | | | 20-25 |
| Example 16 | 4 | 2.61 | 0.46 | 1 | | | | | | 40 |
| Example 17 | 4 | 2.61 | | 1 | 0.046 | | | | | 20 |
| Example 18 | 4.17 | | | 1.22 | | 1.53 | 0.02 | 2.82 | | 50-55 |
| Example 19 | 4.17 | | | 2.44 | | 1.36 | 0.02 | 2.82 | | 50-55 |
| Example 20 | 4.07 | | | 0.32 | | 0.85 | 0.02 | 2.82 | | 55 |
| Example 21 | 4.34 | | | 1.22 | | 0.85 | 0.02 | 2.82 | | 55-60 |
| Example 22 | 4.59 | | | | | 0.85 | 0.02 | 2.82 | | 60-65 |
| Example 23 | 4.38 | | | | | 1.28 | 0.02 | 2.82 | | 55-60 |
| Example 24 | 4 | | | | | 0.85 | 0.02 | 2.82 | | 65-70 |
| Example 25 | 3.5 | | | | | 0.85 | 0.02 | 2.82 | | 65-70 |
| Example 26 | 4.6 | 0.24 | | | | 0.85 | 0.02 | 2.5 | | 60 |
| Example 27 | 5 | 1.06 | | | | | 0.02 | 1.4 | | 40 |
| Example 28 | 5 | 0.5 | | | | | 0.04 | 2.15 | | 55-60 |
| Example 29 | 5 | 0.25 | | | | | 0.02 | 2.48 | | 70 |
| Example 30 | 5 | 0.38 | | | | | 0.02 | 2.31 | | 70 |
| Example 31 | 4.52 | 0.24 | | | | | 0.02 | 2.5 | | 50 |
| Example 32 | 3.75 | 0.5 | | 0.91 | | | 0.04 | 2.15 | | 25-30 |
| Example 33 | 3.75 | 0.38 | | 0.91 | | | 0.04 | 2.31 | | 70 |
| Example 34 | 3.75 | 0.44 | | 0.91 | | | 0.04 | 2.23 | | 70 |
| Example 35 | 3.75 | | | 0.91 | | | 0.04 | 2.15 | | 50-55 |
| Example 36 | 3.89 | | | 0.8 | | | 0.04 | 2.02 | | 60 |
| Example 37 | 3.89 | | | 0.8 | | | 0.04 | 1.5 | | 50-55 |
| Example 38 | 3.75 | | | 0.9 | | | 0.04 | 1.5 | | 50-55 |
| Example 39 | 3.2 | | | 0.95 | | | 0.06 | 1.5 | | 55-60 |
| Example 40 | 3.6 | | | 0.9 | | | 0.08 | 0.73 | | 20-25 |
| Example 41 | 3.1 | | | 0.95 | | | 0.06 | 1.17 | | 65-70 |
| Example 42 | 2.5 | | | | | | 0.02 | 2.1 | | 75-80 |
| Example 43 | 2.5 | | | | | | 0.02 | 3.17 | | 70-75 |
| Example 44 | 2.5 | | | | | | 0.02 | 4 | | 55-62 |
| Example 45 | 2.5 | 0.25 | | | | | 0.02 | 4 | | 55-62 |
| Example 46 | 2 | 0.25 | | 0.4 | | | 0.02 | 4 | | 33 |
| Example 47 | 2 | | | 0.4 | | | 0.02 | 4 | | 45-50 |
| Example 48 | 2.5 | 0.16 | | 0.4 | | | 0.06 | 4 | | 50-55 |
| Example 49 | 2.5 | 0.12 | | 0.8 | | | 0.06 | 4 | | 50-55 |
| Example 50 | 2.5 | 0.04 | | 0.8 | | | 0.06 | 3.5 | | 60 |
| Example 51 | 2.5 | 0.22 | | 0.8 | | | 0.06 | 3.75 | | 40-50 |
| Example 52 | 2.5 | 0.1 | | 0.8 | | | 0.06 | 3.75 | | 50-55 |
| Example 53 | 2.5 | 0.12 | | 0.8 | | | 0.06 | 3.75 | | 55-60 |
| Example 54 | 2.5 | 0.12 | | 0.6 | | | 0.06 | 3.75 | | 55 |
| Example 55 | 2.5 | 0.12 | | 0.6 | | | 0.06 | 3.5 | | 55-60 |
| Example 56 | 2.5 | 0.12 | | 0.6 | | | 0.06 | 3 | | 65-70 |
| Example 57 | 2.5 | 0.12 | | 0.6 | | | 0.06 | 2.5 | | 40 |
| Example 58 | 2.5 | 02 | | 0.6 | | | 0.06 | 3 | | 70 |
| Example 59 | 2.5 | 0.3 | | 0.6 | | | 0.06 | 3 | | 70 |
| Example 60 | 2.5 | 0.4 | | 0.6 | | | 0.06 | 3 | | 60-65 |
| Example 61 | 2.5 | 0.2 | | 0.6 | | | 0.06 | 3.75 | | 55 |
| Example 62 | 2.5 | 0.3 | | 0.6 | | | 0.06 | 3.75 | | 40 |
| Example 63 | 2.5 | 0.4 | | 0.6 | | | 0.06 | 3.75 | | 25-50 |

Additional material concerning microdevices and their fabrication can be found in the following three books which are hereby incorporated herein by reference as if set forth in full herein:

1. Multiple authors, The MEMS Handbook, edited by Mohamed Gad-El-Hak, CRC Press, 2002;

2. M. Madou, Fundamentals of Microfabrication, CRC Press, 2002; and

3. Multiple authors, Micromechanics and MEMS, edited by William Trimmer, IEEE Press, 1997.

In view of the teachings herein, many further embodiments, alternatives in design and uses of the instant invention will be apparent to those of skill in the art. Some of these embodiments may be based on a combination of the teachings herein with one another or various teachings incorporated herein by reference. It is not intended that the invention be limited to the particular illustrative embodiments, alternatives, and uses described above but instead that it be solely limited by the claims presented hereafter.

I claim:

1. A method of forming a conformable contact mask, comprising:
a. applying a liquid composition to a support structure, the liquid composition being applied such that the composition has a desired thickness over the support structure;
b. curing the composition to form a solidified and flexible member on the support structure;
c. laser ablating a selected portion of the flexible member, to form a mask having a desired pattern, the pattern comprising at least one opening extending through the flexible member;
d. wherein the liquid composition comprises:
i) a first component comprising molecules having at least one aromatic ring attached to a silicone backbone that possesses a plurality of SiH functional groups;
ii) a second component comprising molecules having a ring structured polyimide with a plurality of double bond functional groups; and
iii) a catalyst.

2. The method of claim 1 wherein the liquid composition additionally comprises a third component comprising molecules having an aromatic ring backbone with a plurality of double bond functional groups.

3. The method of claim 2 wherein the liquid composition additionally comprises a fourth component comprising molecules having an aromatic ring backbone with a plurality of SiH functional groups.

4. The method of claim 1 wherein the catalyst comprises a platinum catalyst.

5. The method of claim 1 wherein the curing of the composition comprises elevating a temperature of composition.

6. A method of forming a conformable contact mask, comprising:
a. applying a liquid composition to a support structure, the liquid composition being applied such that the composition has a desired thickness over the support structure;
b. curing the composition to form a solidified and flexible member on the support structure;
c. laser ablating a selected portion of the flexible member, to form a mask having a desired pattern, the pattern comprising at least one opening that extends through the flexible member;
wherein the liquid composition comprises:
i) a first component comprising molecules having a silicone backbone and a plurality of SiH functional groups and having a plurality of organic compatibility enhancing groups having structure R;
ii) a second component comprising flexible cyclic molecules having a plurality of double bond functional groups, and.
iii) a catalyst.

7. The method of claim 6 additionally comprising providing a third component comprising molecules having a plurality of SiH functional groups and having a structure compatible with R.

8. The method of claim 7 additionally comprising providing a fourth component comprising radiation absorbing molecules having a plurality of double bond functional groups and having a structure compatible with R.

9. The method of claim 6 wherein the catalyst comprises a platinum catalyst.

10. The method of claim 6 wherein the molecules having a plurality of double bond functional groups and having a structure compatible with R comprise a plurality of structures compatible with R.

11. A method of forming a conformable contact mask, comprising:
a. providing a cured sheet of conformable material having a desired thickness;
b. bonding the sheet of conformable material to a support structure;
c. laser ablating a selected portion of the flexible member, to form a mask having a desired pattern, the pattern comprising at least one opening extending through the flexible member;
d. wherein the conformable material comprises:
i) a first component comprising molecules having at least one aromatic ring attached to a silicone backbone that possesses a plurality of SiH functional groups; and
ii) a second component comprising molecules having a ring structured polyimide with a plurality of double bond functional groups.

12. The method of claim 11 wherein the liquid composition additionally comprises a third component comprising molecules having an aromatic ring backbone with a plurality of double bond functional groups.

13. The method of claim 12 wherein the liquid composition additionally comprises a fourth component comprising molecules having an aromatic ring backbone with a plurality of SiH functional groups.

14. The method of claim 11 wherein the conformable material comprises a catalyst.

15. The method of claim 11 wherein the curing of the composition comprises elevating a temperature of composition.

16. A method of forming a conformable contact mask, comprising:
a. providing a cured sheet of conformable material having a desired thickness;
b. bonding the sheet of conformable material to a support structure;
c. laser ablating a selected portion of the flexible member, to form a mask having a desired pattern, the pattern comprising at least one opening that extends through the flexible member;
wherein the liquid composition comprises:
i) a first component comprising molecules having a silicone backbone and a plurality of SiH functional groups and having a plurality of organic compatibility enhancing groups having structure R; and
ii) a second component comprising flexible cyclic molecules having a plurality of double bond functional groups.

17. The method of claim 16 additionally comprising providing a third component comprising molecules having a plurality of SiH functional groups and having a structure compatible with R.

18. The method of claim 17 additionally comprising providing a fourth component comprising radiation absorbing molecules having a plurality of double bond functional groups and having a structure compatible with R.

19. The method of claim 16 wherein the conformable material comprises a catalyst.

20. The method of claim 16 wherein the molecules having a plurality of double bond functional groups and having a structure compatible with R comprise a plurality of structures compatible with R.
